(19) United States
(12) Patent Application Publication
(10) Pub. No.: US 2009/0036596 A1
(43) Pub. Date: Feb. 5, 2009

(54) METHOD FOR PRODUCING RUBBER-FILLER COMPOSITE

(75) Inventors: Takashi Miyasaka, Osaka (JP); Takashi Yuri, Osaka (JP); Hiroaki Narita, Osaka (JP); Hirofumi Hayashi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/178,765

(22) Filed: Jul. 24, 2008

(30) Foreign Application Priority Data
Jul. 30, 2007 (JP) 2007-197328

(51) Int. Cl. C08L 7/00

(52) U.S. Cl. 524/575.5

(57) ABSTRACT

In a rubber-filler composite, the filler is uniformly finely dispersed, thereby improving low heat build-up, fatigue resistance and processability of a rubber composition. The rubber-filler composite is obtained by irradiating a filler slurry containing a filler such as carbon black or silica with high amplitude ultrasonic waves having amplitude of 80 μm or more to finely disperse the filler in the slurry, and mixing the dispersion-treated filler slurry with a concentrated natural rubber latex while conducting irradiation with high amplitude ultrasonic waves having amplitude of 80 μm or more, followed by coagulating and drying.

### CROSS-REFERENCE TO RELATED APPLICATIONS

This application is based upon and claims the benefit of priority from the prior Japanese Patent Application No. 2007-197328, filed on Jul. 30, 2007; the entire contents of which are incorporated herein by reference.

### BACKGROUND

The present invention relates to a method for producing a rubber-filler composite which is a composite of a rubber and a filler. More particularly, it relates to a method for producing a rubber-filler composite which is used as a masterbatch, comprising a natural rubber and a filler such as carbon black or silica dispersed therein.

For the purpose of reinforcement or the like, a filler such as carbon black is blended with a rubber composition used in tires or the like. Conventionally, blending of such a filler and a rubber has employed a method of adding a filler in a form of a powder to a rubber and then kneading those, called dry mixing. However, there is the limit to uniformly finely disperse the filler to a rubber by this method.

In view of the above, it is recently proposed that a rubber-filler composite called a wet masterbatch is prepared by mixing a filler slurry comprising a filler such as carbon black or silica previously dispersed in water, and a rubber latex, and this is blended with a rubber composition (see US 2004/0109944 A1, U.S. Pat. No. 4,788,231 A, U.S. Pat. No. 4,883,829 A, JP-A-2004-66204 and JP-A-2006-152117). It is found that low heat build-up, abrasion resistance on rough road, and the like are improved.

However, in the conventional production method of a rubber-filler composite, grinding of aggregated fillers is insufficient, and it is difficult to maximize the performance of a filler.

For example, US 2004/0109944 A1, U.S. Pat. No. 4,788,231 A and U.S. Pat. No. 4,883,829 A disclose that a filler slurry and a rubber latex are mixed by a blade stirrer, and a coagulation is obtained by decrease in pH and addition of a salt. However, in those documents, as a method for preparing a filler slurry general stirring and dispersion apparatus are used, and dispersion of the filler is insufficient.

JP-A-2004-66204 discloses to obtain a coagulation by irradiating a mixed solution of a filler slurry and a rubber latex with ultrasonic waves. However, the filler slurry is not previously irradiated with high amplitude ultrasonic waves, and therefore dispersion of the filler is insufficient. Specifically, in JP-A-2004-66204 ultrasonic waves are used to obtain a coagulation of a filler and a rubber from the above mixed solution, and this quite differs in how to use ultrasonic waves from the present invention that a filler is finely dispersed by ultrasonic waves.

JP-A-2006-152117 discloses that a masterbatch obtained by mixing and coagulating a carbon black slurry and a rubber latex is used, and bismaleimide is added to a rubber component comprising an isoprene rubber and trans-polybutadiene, thereby improving crack resistance and low heat build-up. This document exemplifies an ultrasonic homogenizer together with a rotor-stator type high shear mixer, high pressure homogenizer or the like as an apparatus used in the preparation of a filler slurry (paragraph 0040). However, the working examples do not contain any embodiment specifically using an ultrasonic homogenizer, and there is no disclosure to show that a filler is highly finely dispersed using high amplitude ultrasonic waves.

### SUMMARY

The present invention has been made in view of the above circumstances, and has an object to provide a method for producing a rubber-filler composite, in which the performance of the rubber-filler composite can be maximized by uniformly finely dispersing a filler in a rubber-filler composite than ever before, and low heat build-up, fatigue resistance and processability can be improved when the composite is blended with a rubber composition.

The method for producing a rubber-filler composite according to the present invention comprises a dispersion step of irradiating a filler slurry containing a filler with high amplitude ultrasonic waves having amplitude of 80 μm or more to finely disperse the filler in the slurry, and a mixing step of mixing the dispersion-treated filler slurry with a concentrated natural rubber latex.

Preferably, the dispersion-treated filler slurry and the concentrated natural rubber latex are mixed in the mixing step while conducting irradiation with high amplitude ultrasonic waves having amplitude of 80 μm or more.

According to the present invention, when the filler slurry is irradiated with high amplitude ultrasonic waves having amplitude of 80 μm or more prior to mixing with the rubber latex, cavitation is generated, making it possible to generate deaggregation of a filler and to highly finely disperse the filler. Due to this, the filler can uniformly be finely dispersed in a rubber by mixing the thus dispersion-treated filler slurry with the rubber latex. Therefore, when a rubber-filler composite which is the rubber coagulation obtained is used in a rubber composition, the performance of the rubber-filler composite can be maximized, and low heat build-up, fatigue resistance and processability of the rubber composition can be improved. Furthermore, by using the concentrated natural rubber latex as a rubber latex, low heat build-up can further be enhanced in a synergistic effect.

In mixing, where the dispersion-treated filler slurry and the concentrated natural rubber latex are mixed while conducting irradiation with high amplitude ultrasonic waves having amplitude of 80 μm or more, the concentrated natural rubber latex can be mixed while preventing reaggregation of the filler slurry, and the performance of the rubber-filler composite can be developed more effectively.

### DETAILED DESCRIPTION OF THE INVENTION

Articles related to an embodiment of the invention will be explained in details as follows.

In the present invention, various inorganic fillers such as carbon black, silica, clay or zeolite can be used as the filler. Those fillers can be used alone or as mixtures of two or more thereof. Preferably, carbon black, silica or a mixture thereof is used. The silica includes wet silica, dry silica and colloidal silica.

A filler slurry comprises the filler dispersed in an aqueous solvent such as water. Such a filler slurry can be obtained by, for example, adding water to a filler and stirring the mixture with a stirring machine. The content of the filler in the filler slurry is preferably 1 to 20% by weight from the points of grinding effect in the dispersion step and mixing effect of the filler with the rubber latex in the mixing step. The content of filler is more preferably 2 to 10% by weight.

The present invention uses a concentrated natural rubber latex as a rubber latex. The concentrated natural rubber latex is such that a field latex (generally, rubber concentration (DRC: Dry Rubber Content) is 20 to 35 wt %) of a natural rubber collected by tapping from a natural rubber tree is concentrated by, for example, removing protein by the conventional concentration method such as centrifugal separation, thereby increasing a rubber concentration. The rubber concentration (DRC) of the concentrated natural rubber latex used in the present invention is preferably 50% by weight or more, and more preferably 50 to 70% by weight.

In the method for producing a rubber-filler composite according to the present invention, the filler slurry is subjected to fine dispersion treatment in the dispersion step. The fine dispersion treatment is conducted by irradiating the filler slurry with high amplitude ultrasonic waves having amplitude of 80 μm or more. The irradiation of such high amplitude ultrasonic waves generates cavitation in the filler slurry. The cavitation is that micropores generated by decrease of local pressure in a liquid are continuously collapsed, thereby repeatedly imparting violent shock to the filler. This induces deaggregation of the filler, and the filler is highly finely dispersed.

Conventionally, fine dispersion treatment with such high amplitude ultrasonic waves has not be conducted at all to the rubber-filler composite particularly for use in tires, and it has not been considered that the fine dispersion treatment with such high amplitude ultrasonic waves gives practically advantageous effect to the tire performance. In other words, it has been required to uniformly disperse the filler in a rubber, but highly fine dispersion to such a degree has not been required. The present invention has found that treatment with high amplitude ultrasonic waves gives practically advantageous effect as a rubber-filler composite used in tires or the like.

The term “ultrasonic waves” used herein means acoustic wave having a frequency of 20 kHz or more. The frequency is preferably 20 to 100 kHz, and more preferably 20 to 50 kHz.

In the present invention, the amplitude of such an ultrasonic wave is set to high amplitude of 80 μm or more. When the amplitude is smaller than 80 μm, cavitation is weak, and deaggregation of the filler becomes insufficient. The amplitude of the ultrasonic wave is preferably 100 to 260 μm. It is difficult at present to generate ultrasonic waves having amplitude exceeding 260 μm Furthermore, in such ultrasonic waves having amplitude exceeding 260 μm, generation of heat of an ultrasonic generator itself is increased, and energy loss is large.

A method of the irradiation of ultrasonic waves is not particularly limited so long as the filler slurry can uniformly be irradiated with ultrasonic waves having the above amplitude. Preferred method is a batchwise method, such as a method of placing a filler slurry in a vessel, dipping a sonotrode of an ultrasonic generator in the filler slurry, and treating the filler slurry with ultrasonic waves generated from the sonotrode for a given period of time.

In the dispersion step, various dispersants such as anionic, cationic, nonionic or amphoteric dispersants can previously be added to the filler slurry. Specifically, examples of the dispersant include a sodium salt of β-naphthalenesulfonic acid-formalin condensate, lauryltrimethylammonium chloride, polyoxyethylene distyrenated phenyl ether and laurylbetaine. Those can be used alone or as mixtures of two or more thereof.

In the subsequent mixing step, the dispersion-treated filler slurry and the concentrated natural rubber latex are mixed. In such a case, the dispersion-treated filler slurry and the concentrated natural rubber latex are preferably mixed while conducting the irradiation with high amplitude ultrasonic waves having amplitude of 80 μm or more. This enables the rubber latex to be mixed while preventing reaggregation of the filler slurry. When the irradiation with ultrasonic waves is conducted in the mixing step, in a continuous flow type mixing step such that a mixed liquid is sequentially led to a downstream side while joining and mixing the filler slurry and the concentrated natural rubber latex with small portions, it is preferred that a sonotrode of an ultrasonic generator is dipped in the mixed liquid just after joining together, and the irradiation with ultrasonic waves is conducted. This can prevent undesired aggregation of the filler and the natural rubber. The frequency and amplitude of ultrasonic waves irradiated in the mixing step are the same as those in the dispersion step described before.

The mixing ratio of the filler slurry and the concentrated natural rubber latex is preferably that the amount of the filler is 20 to 80 parts by weight per 100 parts by weight of a rubber polymer.

The mixed liquid of the finely dispersed filler slurry and the concentrated natural rubber latex undergoes coagulating and drying steps according to the conventional method, and a solid rubber-filler composite is obtained.

The rubber-filler composite obtained can be used as a masterbatch in preparing a rubber composition for vulcanization. In such a rubber composition, a rubber component may be only a material added as the rubber-filler composite, but other rubbers may be added together with the rubber-filler composite. Examples of other compounding agent include oils, antioxidants, zinc white, stearic acid, softeners, vulcanizing agents and vulcanization accelerators, but the compounding agent is not particularly limited.

The rubber composition having compounded therewith the rubber-filler composite can maximize the performance of the filler, making it possible to improve low heat build-up, high fatigue resistance and processability. Therefore, such a rubber composition can preferably be used in rubber compositions for tires, such as tread rubber or side wall rubber of tires, and additionally in various rubber compositions.

### EXAMPLES

The present invention is described in detail below by reference to the following Examples, but the invention is not limited to those Examples.

### [Preparation of Masterbatch]

Each masterbatch of Examples 1 to 10 and Comparative Examples 1 to 4 was prepared as follows.

### Example 1

In a dispersion step, water was added to carbon black (a product of Mitsubishi Chemical Corporation, MA600, BET specific surface area (specific surface area obtained by S-BET formula from adsorbed amount of nitrogen according to JIS K6217)=140 m²/g) so as to be an amount of 5% by weight, and the resulting mixture was stirred with a stirring machine (stirring rate: 50 m/sec) to obtain a carbon black slurry. 600 g of the carbon black slurry thus obtained was placed in a 1 liter vessel. UP-400S, a product of Nihon SiberHegner K.K., was used as a high amplitude ultrasonic generator. A sonotrode of the generator was placed in the carbon black slurry, and the carbon black was finely dispersed by the irradiation with ultrasonic waves having a frequency of 30 kHz and amplitude of 80 μm for 20 minutes.

Subsequently, in a mixing step, 600 g of the carbon black slurry dispersed as above and 100 g of a concentrated natural rubber latex (a product of REGITEX Co., Ltd., NR LATEX, DRC=60 wt %) were mixed while irradiating with high amplitude ultrasonic waves from UP-400S, a product of Nihon SiberHegner K.K. The mixing was conducted by the continuous flow type mixing step described above, and was conducted by irradiating the carbon black slurry (flow rate=50 ml/min) just after joining with ultrasonic waves having a frequency of 30 kHz and amplitude of 80 μm from the sonotrode of the ultrasonic generator. By conducting the mixing as above, a coagulation of a carbon masterbatch was obtained. The coagulation obtained was dried at 50° C. under reduced pressure of 0.1 MPa for 30 hours or more to prepare a masterbatch (containing 50 parts by weight of carbon black per 100 parts by weight of natural rubber).

### Example 2

A masterbatch was prepared in the same manner as in Example 1, except that the amplitude of ultrasonic waves in the dispersion step and mixing step was set to 130 μm.

### Example 3

A masterbatch was prepared in the same manner as in Example 1, except that the amplitude of ultrasonic waves in the dispersion step and mixing step was set to 210 μm.

### Example 4

A masterbatch was prepared in the same manner as in Example 1, except that UP-200S, a product of Nihon SiberHegner K.K., was used as a high amplitude ultrasonic generator used in the dispersion step, the amplitude of ultrasonic waves in the dispersion step was set to 260 μm, and the amplitude of ultrasonic waves in the mixing step was set to 100 μm.

### Example 5

A masterbatch was prepared in the same manner as in Example 4, except that a dispersant (a product of Kao Corporation, DEMOL N, sodium salt of β-naphthalenesulfonic acid-formalin condensate: anionic) was added together with water to carbon black so as to be an amount of 0.3 wt % to prepare a carbon black slurry.

### Example 6

A masterbatch was prepared in the same manner as in Example 1, except that the carbon black slurry and the concentrated natural rubber latex were mixed without irradiation with ultrasonic waves in the mixing step.

### Example 7

A masterbatch was prepared in the same manner as in Example 2, except that the carbon black slurry and the concentrated natural rubber latex were mixed without irradiation with ultrasonic waves in the mixing step.

### Example 8

A masterbatch was prepared in the same manner as in Example 3, except that the carbon black slurry and the concentrated natural rubber latex were mixed without irradiation with ultrasonic waves in the mixing step.

### Example 9

A masterbatch was prepared in the same manner as in Example 4, except that the carbon black slurry and the concentrated natural rubber latex were mixed without irradiation with ultrasonic waves in the mixing step.

### Example 10

A masterbatch was prepared in the same manner as in Example 5, except that the carbon black slurry and the concentrated natural rubber latex were mixed without irradiation with ultrasonic waves in the mixing step.

### Comparative Example 1

A masterbatch was prepared in the same manner as in Example 1, except that 200 g of a field latex (a product of Golden Hope, NR LATEX, DRC (rubber content)=30 wt %) was used in place of 100 g of the concentrated natural rubber latex, and the amplitude of ultrasonic waves in the dispersion step and the mixing step was set to 100 μm.

### Comparative Example 2

A masterbatch was prepared in the same manner as in Example 1, except that irradiation with ultrasonic waves was not conducted in the dispersion step and the mixing step.

### Comparative Example 3

A masterbatch was prepared in the same manner as in Example 1, except that Phenix Legend (75101 Model), a product of KAIJO Corporation, was used as an ultrasonic generator used in the dispersion step and the mixing step, and the amplitude of the ultrasonic waves was set to 2 to 3 μm.

### Comparative Example 4

A masterbatch was prepared in the same manner as in Comparative Example 3, except that the carbon black slurry and the concentrated natural rubber latex were mixed without irradiation with ultrasonic waves in the mixing step.

### [Evaluation of Masterbatch]

A rubber composition was prepared using each masterbatch obtained above. The formulation of the rubber composition was the masterbatch: 150 parts by weight (rubber component: 100 parts by weight), stearic acid (a product of Kao Corporation, LUNAC S25): 1 part by weight, antioxidant (a product of Monsanto, 6PPD): 1 part by weight, zinc white (a product of Mitsui Mining and Smelting Co., Ltd., Zinc White No. 1): 3 parts by weight, wax (a product of Nippon Seiro Co., Ltd., OZOACE 0355): 1 part by weight, sulfur (a product of Tsurumi Kagaku Kogyo K.K., 5% oil-containing sulfur fine powder): 2 parts by weight, and vulcanization accelerator (a product of Sanshin Chemical Industry Co., Ltd., CBS): 1 part by weight.

Dispersibility, fatigue property, heat build-up and processability of each rubber composition obtained were evaluated, and the results obtained are shown in Table 1. Each evaluation method is as follows. The vulcanization conditions were 150° C. and 30 minutes.

Dispersibility: Measured according to ASTM D2663-69, method B

Fatigue property: Measured according to JIS K6270. Indicated by index as Comparative Example 1 being 100. Larger index means good fatigue resistance (crack resistance).

Heat build-up: Measured according to JIS K6265. Indicated by index as Comparative Example 1 being 100. Smaller index means low exothermic temperature and good low heat build-up.

Processability: Measured according to JIS K6300-1. Indicated by index as Comparative Example 1 being 100. Smaller index means low Mooney viscosity and good processability.

TABLE 1

| | | Com. | Com. | Com. | Com. | | | | |
|---|---|---|---|---|---|---|---|---|---|
| | | Ex. 1 | Ex. 2 | Ex. 3 | Ex. 4 | Ex. 1 | Ex. 2 | Ex. 3 | Ex. 4 |
| Dispersion | Ultrasonic | UP- | None | Phenix | Phenix | UP- | UP- | UP- | UP- |
| step | treater | 400S | | Legend | Legend | 400S | 400S | 400S | 200S |
| | Amplitude | 100 | | 2-3 | 2-3 | 80 | 130 | 210 | 260 |
| | (μm) | | | | | | | | |
| | Presence or | None | None | None | None | None | None | None | None |
| | absence of | | | | | | | | |
| | dispersant | | | | | | | | |
| Mixing | Ultrasonic | UP- | None | Phenix | None | UP- | UP- | UP- | UP- |
| step | generator | 400S | | Legend | | 400S | 400S | 400S | 400S |
| | Amplitude | 100 | | 2-3 | | 80 | 130 | 210 | 100 |
| | (μm) | | | | | | | | |
| | Natural | Field | Concentrated | Concentrated | Concentrated | Concentrated | Concentrated | Concentrated | Concentrated |
| | rubber latex | | | | | | | | |

| | | | | | | | | |
|---|---|---|---|---|---|---|---|---|
| Dispersibility (%) | 99.4 | 97.8 | 97.9 | 97.8 | 98.7 | 98.8 | 98.9 | 99.3 |
| Fatigue property | 100 | 93 | 103 | 102 | 109 | 110 | 112 | 114 |
| Heat build-up | 100 | 102 | 100 | 100 | 87 | 86 | 85 | 84 |
| Processability | 100 | 125 | 99 | 99 | 84 | 83 | 82 | 81 |

| | | Ex. 5 | Ex. 6 | Ex. 7 | Ex. 8 | Ex. 9 | Ex. 10 |
|---|---|---|---|---|---|---|---|
| Dispersion | Ultrasonic | UP- | UP- | UP- | UP- | UP- | UP- |
| step | treater | 200S | 400S | 400S | 400S | 200S | 200S |
| | Amplitude | 260 | 80 | 130 | 210 | 260 | 260 |
| | (μm) | | | | | | |
| | Presence or | Present | None | None | None | None | Present |
| | absence of | | | | | | |
| | dispersant | | | | | | |
| Mixing | Ultrasonic | UP- | None | None | None | None | None |
| step | generator | 400S | | | | | |
| | Amplitude | 100 | | | | | |
| | (μm) | | | | | | |
| | Natural | Concentrated | Concentrated | Concentrated | Concentrated | Concentrated | Concentrated |
| | rubber latex | | | | | | |

| | | | | | | |
|---|---|---|---|---|---|---|
| Dispersibility (%) | 99.5 | 98.5 | 98.6 | 98.7 | 99.0 | 99.3 |
| Fatigue property | 116 | 108 | 109 | 110 | 112 | 114 |
| Heat build-up | 82 | 88 | 87 | 86 | 85 | 83 |
| Processability | 80 | 85 | 85 | 83 | 82 | 80 |

As shown in Table 1, in the rubber composition using the carbon black/natural rubber composite of the Examples according to the present invention, the dispersibility of carbon black is apparently improved as compared with the compositions of the Comparative Examples 2 to 4, and fatigue resistance, low heat build-up and processability were greatly improved. Further, fatigue resistance, low heat build-up and processability were greatly improved as compared with Comparative Example 1 using a field latex as a rubber latex.

### Examples 11 to 14 and Comparative Examples 5 and 6

Each of masterbatches of Examples 11 to 14 and Comparative Examples 5 and 6 was prepared in the same manners as in Examples 1 to 4 and Comparative Examples 2 and 3, respectively, except for using Printex 90, a product of Degussa AG (BET specific surface area=300 m²/g)) as a filler.

Rubber compositions were prepared using the masterbatches obtained. The formulation of the rubber composition is the same as in Example 1.

Dispersibility, fatigue property, heat build-up and processability of each rubber composition obtained were evaluated, and the results are shown in Table 2. Each evaluation method is the same as above (Regarding the index, the value of Comparative Example 5 was used as 100).

TABLE 2

| | | Com. | Com. | | | | |
|---|---|---|---|---|---|---|---|
| | | Ex. 5 | Ex. 6 | Ex. 11 | Ex. 12 | Ex. 13 | Ex. 14 |
| Dispersion | Ultrasonic | None | Phenix | UP- | UP- | UP- | UP- |
| step | treater | | Legend | 400S | 400S | 400S | 200S |
| | Amplitude | | 2-3 | 80 | 130 | 210 | 260 |
| | (μm) | | | | | | |
| | Presence of | None | None | None | None | None | None |
| | absence of | | | | | | |
| | dispersant | | | | | | |
| Mixing | Ultrasonic | None | Phenix | UP- | UP- | UP- | UP- |
| step | generator | | Legend | 400S | 400S | 400S | 400S |
| | Amplitude | | 2-3 | 80 | 130 | 210 | 100 |
| | (μm) | | | | | | |
| | Natural rubber | Concentrated | Concentrated | Concentrated | Concentrated | Concentrated | Concentrated |
| | latex | | | | | | |

| | | | | | | |
|---|---|---|---|---|---|---|
| Dispersibility (%) | 96.5 | 96.8 | 97.5 | 97.7 | 97.9 | 98.1 |
| Fatigue property | 100 | 102 | 110 | 110 | 112 | 114 |
| Heat build-up | 100 | 98 | 94 | 94 | 93 | 92 |
| Processability | 100 | 99 | 87 | 85 | 83 | 81 |

What is claimed is:

1. A method for producing a rubber-filler composite, comprising:
a dispersion step of irradiating a filler slurry containing a filler with high amplitude ultrasonic waves having amplitude of 80 μm or more to finely disperse the filler in the slurry, and
a mixing step of mixing the dispersion-treated filler slurry with a concentrated natural rubber latex.

2. The method for producing a rubber-filler composite as claimed in claim 1, wherein the dispersion-treated filler slurry and the concentrated natural rubber latex are mixed in the mixing step while conducting irradiation with high amplitude ultrasonic waves having amplitude of 80 μm or more.

3. The method for producing a rubber-filler composite as claimed in claim 1, wherein the filler is carbon black.

4. A rubber-filler composite produced by the method claimed in claim 1.

5. A rubber composition using the rubber-filler composite as claimed in claim 4.
